(19) United States
(12) Patent Application Publication
(10) Pub. No.: US 2015/0368556 A1
(43) Pub. Date: Dec. 24, 2015

(54) METHOD OF SYNTHESIZING COMPOSITE PHOSPHOR BY PHASE TRANSITION

(71) Applicant: NATIONAL CHUNG SHAN INSTITUTE OF SCIENCE AND TECHNOLOGY, Longtan Township (TW)

(72) Inventors: Yin-Chih LIN, Hsinchu City (TW); Shin-Mou WU, Tainan City (TW); Hao-En HUNG, Taipei City (TW); Yi-Ting TSAI, New Taipei City (TW); Chun-Che LIN, Dongshan Township (TW); Ru-Shi LIU, New Taipei City (TW); Li-Chun WANG, Longtan Township (TW); Chi-Hsing HSIEH, Taipei City (TW)

(21) Appl. No.: 14/307,518

(22) Filed: Jun. 18, 2014

(51) Int. Cl. C09K 11/77; C09K 11/55; C09K 11/59

(52) U.S. Cl. CPC C09K 11/77; C09K 11/59; C09K 11/55

(57) ABSTRACT

A method of synthesizing a composite phosphor by phase transition, characterized by controlling the sintering temperature and duration, changing M_{2-y}Si₅N₈:R_{y} phase to M₁₋ₓSi₆N₈ : Rₓ phase, thereby forming a two-phase composite phosphor, wherein proportions of the two phases of the composite phosphor are variable. As indicated by its varying CIE color coordinates, Sr_{1.98}Si₅N₈:Eu²⁺_{0.02} changes from red to pink, and then to blue. The CIE color coordinates are collinear. If there is no color deviation at the two ends of the straight line, the coordinates of any color resulting from a mixture of two colors will lie on the straight line. The aforesaid synthesis method dispenses with the hassles of sintering two colored phosphors separately, thus attaining uniformity of resultant light color and cutting the costs of phosphor synthesis.

### FIELD OF TECHNOLOGY

The present invention relates to methods of synthesizing phosphor, and more particularly, to a method of synthesizing a composite phosphor by phase transition, and the method involves sintering three reactants in a single instance at a well-controlled sintering temperature and sintering duration to synthesize phosphor M₁₋ₓSi₆N₈:Rₓ phase and M_{2-y}Si₅N₈ : R_{y} phase at different ratios, thereby bringing about phosphorescence of different colors.

### BACKGROUND

In recent years, as increasing importance is attached to environmental protection and power saving, white light-emitting diodes (WLEDs) have the potential to become the next-generation light source, because WLEDs feature low power consumption (with a conversion efficiency of around 50%, which is 10 times larger than that of conventional incandescent lamps and 2˜3 times larger than that of conventional fluorescent lamps), low heat radiation, non-toxicity, long service life (of 100,000 hours, whereas conventional incandescent lamps have a service life of just hundreds of hours, and conventional fluorescent lamps have a service life of around 6,000˜30,000 hours), compactness, and quick response. In Taiwan, where the disputed construction of a fourth nuclear power plant divides the Taiwanese society, if one fourth of incandescent lamps and fluorescent lamps in use in Taiwan were replaced by white light-emitting diodes (white LEDs), 11 billion kilowatt-hour (kWh) of electric power (equivalent to the amount of electric power generated by an average nuclear power plant yearly) would be saved each year. Hence, at present, heatedly-debated issues include development of new energy sources and enhancement of energy efficiency. Over the past decade, color LEDs are widely used in color illumination, display units, and entertainment-oriented products. Among these applications, the electronic display unit industry is the speediest in terms of development and thus is expected to play an important role in optoelectronic application in the near future.

International LED giants are currently racing to develop high RGB color rendering white LEDs. A white LED system based on a combination of ultraviolet-LED (UV-LED) and red-green-blue phosphor (RGB phosphor) surpasses a white LED system based on a combination of blue LED and Ce-doped Yttrium aluminum garnet, YAG, Y₃Al₅O₁₂:Ce³⁺) yellow phosphor in terms of light emission efficiency and color rendering. As regards the white LED system based on a combination of blue LED and yellow phosphor, the intensity of the blue light emitted from the blue LED varies with the magnitude of the input current, thereby leading to the halo effect. Moreover, LED chip aging is accompanied by the attenuation of the blue light intensity, thereby leading to a lack of uniformity in light color. Nonetheless, the white LED system based on a combination of blue LED and yellow phosphor remains a mainstream product, because of its high brightness and simple design. On the contrary, the UV light emitted from the UV-LED is invisible light, and thus in the event of the attenuation of the intensity of the UV light emitted from the UV-LED, both phosphor efficiency and color rendering will remain unabated. In practice, it is rather difficult for the UV-LED to operate in conjunction with various phosphors, because light emission efficiency varies from phosphor to phosphor; nonetheless, it is anticipated that in the foreseeable future illumination will have a trend toward the application of UV-LEDs, because UV-LEDs approximate to natural lighting in terms of high color rendering and wavelength range.

Matching an excited wavelength and the color of the light emitted is an important prerequisite to the application of phosphor in a white LED system. Dopants, activators, and host materials which contain inorganic fluorescent materials are likely to affect the excitation and light emission of fluorescent materials. Plenty of conventional fluorescent materials are applicable to the excitation of short wavelength UV frequency rather than the excitation of long wavelength UV or visible light frequency and thus are inapplicable to LED light conversion.

Due to its light emission principle, phosphor is regarded as a solid-state light emission material which absorbs electromagnetic radiation and emits light—a phenomenon known as photoluminescence. Phosphor present in bulk, such as (SrBaMg)₂SiO₄:Eu²⁺, comprises a host material, that is, (SrBaMg)₂SiO₄. Phosphor develops its light emission capability by including a trace of foreign ions as dopant, that is, Eu²⁺, in the host. When a foreign ion is incorporated into the host lattice to form a center which is excitable to emit light, it is referred to as an activator. When a foreign ion is incorporated into the host lattice and is capable of transferring its excitation energy to a neighboring activator to cause the activator to emit light, the foreign ion is referred to a sensitizer or co-activator. The activator, which is capable of emitting light, does not take in excitation energy markedly, but the sensitizer takes in excitation energy and transfers the excitation energy to the activator to cause the activator to emit light. During the photoluminescence process, the subject matter absorbs external light energy such that electrons in the electronic ground state S0 jump into excited states. Afterward, the electrons which have jumped into excited states relax and occupy the lowest-oscillating-energy state among the excited states.

Ultraviolet (UV) has a broad ranges of wavelength, including long-wavelength UV with a wavelength shorter than that of blue light, short-wavelength UV emitted from a mercury lamp, and vacuum UV with a wavelength of a mere 100 nm. In general, visible light has a wavelength λ=400˜800 nm, whereas UV has a wavelength λ=200˜400 nm. In the past, research conducted on UV-excited phosphor focuses mainly on short wavelength (˜254 nm) excited phosphor, that is the phosphor for use in a tri-wavelength fluorescent lamp, wherein the phosphor usually comprises BaMgAl₁₀O₁₇:Eu, (Ce,Tb)MgAl₁₁O₁₉, (Ce,Gd,Tb)MgAl₁₁O₁₉, LaPO4:Ce,Tb, Y₂O₃:Eu. The short wavelength (˜254 nm) excited phosphor is also for use in a high-voltage mercury discharge lamp, wherein high-voltage mercury emits a light of a wavelength 250˜550 nm, and the light is greenish blue, and thus the required phosphor must be able to be excited by UV and blue light in order to emit red light. The high-voltage mercury discharge lamp operates a high temperature of 300° C., and thus phosphor must have a high quenching temperature. In the past, the phosphor for use in the high-voltage mercury discharge lamp contains (Zn,Cd)S:Cu. Since the temperature-related properties of sulfides are unsatisfactory, the (Zn,Cd)S:Cu is replaced with Mg₄GeO_{5.5}:Mn and (Sr,Mg)₃ (PO₄)₂:Sn in order to improve the high-voltage mercury discharge lamp. In recent years, the phosphor for use in the high-voltage mercury discharge lamp essentially contains Y (P,V,B)O₄:Eu which has a narrow frequency range, high light emission efficiency, and high thermal stability.

The phosphor for use in UV-LED operates in conjunction with an excitation light source which is UV with a wavelength of 360˜400 nm. The phosphor is exemplified by US-based General Electric's A₂₋₂ₓNa₁₊ₓEₓD₂V₃O₁₂=Ca,Ba, and Sr;E=Eu,Dy,Sm,Tm, and Er;D=Mg, Zn; x=0.01˜0.3) (EP1138747), (Ba_{1-x-y-z}, Caₓ,Sr_{y},Eu_{z})₂(Mg_{1-w},Zn_{w})Si₂O₇ (x+y+z=1; 0.05>z>0; 0.05>w) (U.S. Pat. No. 6,255,670), AP₂O₇:Eu,Mn (A=Sr,Ca,Ba, and Mg) (WO0189000), 3.5 MgO 0.5 MgF₂·GeO₂:Mn⁴⁺ (WO0189001). Due to recent advancements of nitride materials, nitride phosphor draws scientists' attention increasingly because of its excellent chemical properties and high thermal stability. For example, M₂₋ₓSi₅N₈:Euₓ (EP1104799A1) published by Professor Hintzen et al. of Technische Universiteit Eindhoven, M₁₋ₓSi₆N₈:Euₓ (US20130075660) and Sr₁₋₂ₓSi₆N₈:Ce³⁺ₓ, Li⁺ₓ reported by a research team led by Professor Liu Ru-shi of National Taiwan University can be excited by UV to emit light. In this regard, M₂₋ₓSi₅N₈:Euₓ (EP1104799A1) is a red phosphor, whereas M₁₋ₓSi₆N₈:Euₓ (US20130075660) and Sr₁₋₂ₓSi₆N₈:Ce³⁺ₓ, Li⁺ₓ are a blue phosphor each.

A conventional phosphor with a composite color, such as pink phosphor, must be synthesized by the following process: mixing and blending a red phosphor and a blue phosphor at room temperature, and then the mixture of the phosphors is irradiated by excitation light to thereby emit pink light. However, two phosphors in an encapsulant undergo sedimentation and separation because of a difference in particle diameter of the two phosphors, thereby leading to a lack of uniformity in LED light color and unstable quality of the light emitted.

### SUMMARY

The present invention proposes a sintering method for synthesizing a chemical composition whose chromaticity coordinates lie on a straight line connecting the respective chromaticity coordinates of M₁₋ₓSi₆N₈:R_{y} and M_{2-y}Si₅N₈:R_{y} (R denotes a rare earth metal ion, such as Eu²⁺, Ce³⁺) shown in the Commission Internationale de l'Éclairage (CIE) xy chromaticity diagram. Take Sr_{2-y}Si₅N₈:Eu²⁺_{y} as an example, it is treated with the sintering method of the present invention to form a composite-phase pink phosphor composed of a blue phosphor Sr₁₋ₓSi₆N₈:Eu²⁺ₓ and a red phosphor Sr_{2-y}Si₅N₈:Eu²⁺_{y}. According to the present invention, by means of solid-state synthesis, it is practicable to produce a mixed-phase including the aforesaid two colored phosphors in a single instance of high-temperature sintering process and control the ratio of the two colored phosphors by altering the sintering temperature and sintering duration. According to the present invention, after being subjected to UV-photoluminescence or blue-photoluminescence, the phosphor phosphoresces. According to the present invention, the composite colored phosphor comprises M₁₋ₓSi₆N₈:R_{y} phase and M_{2-y}Si₅N₈:R_{y} phase which occupy respective color regions on CIE color coordinates, depending on the sintering duration. Both the M₁₋ₓSi₆N₈:R_{y} phase and M_{2-y}Si₅N₈:R_{y} phase lie on the straight line which connects the respective CIE coordinates of two pure phase phosphors. The aforesaid synthesis of the present invention dispenses with the hassles of sintering two colored phosphors separately, and thus the aforesaid synthesis of the present invention cuts the costs of phosphor synthesis. Furthermore, the mixed-phase phosphor which consists of two colored phosphors can be polished and screened to form a composite colored phosphor that demonstrate a high degree of uniformity in color.

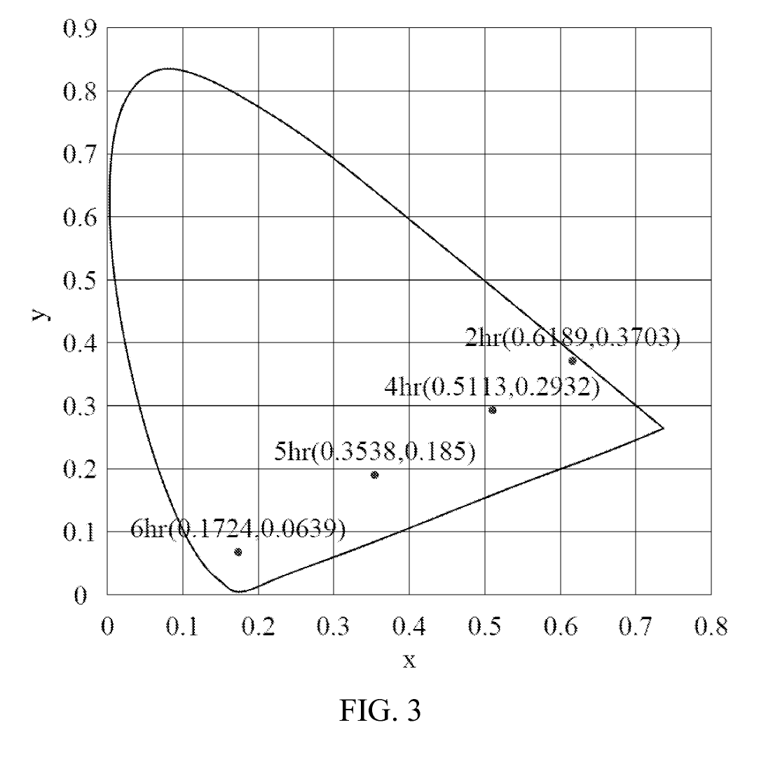

According to the rendering system announced jointly by the Comite International des Poids et Mesures (CIPM) and the Commission Internationale de l'Éclairage (CIE), the phosphor manufactured by the present invention undergoes UV-photoluminescence, and then a straight line that connects the blue coordinates and red coordinates in the CIE xy color coordinate diagram is drawn in accordance with the result of the analysis of the relationship of the human vision and visible light. With the CIE 1931 RGB rendering system, the aforesaid analysis entails matching a known light source, such as red, green, and blue, and an equal-energy spectrum of an unknown light whose wavelength falls within the wavelength range 400 nm˜700 nm, and then converting the result of the match mathematically into color coordinates in the CIE xy color coordinate diagram, where x denotes the horizontal axis, y denotes the vertical axis, and the color coordinates serve as a mean of quantifying a color. The x color coordinate indicates the proportion of red (a primary color) in the unknown light. The y color coordinate indicates the proportion of green (a primary color) in the unknown light. FIG. 3 shows a tongue-shaped spectrum. The red components of the spectrum are found at the lower right portion of the spectrum. The green components of the spectrum are found at the upper portion of the spectrum.

The blue components of the spectrum are found at the lower left portion of the spectrum. The white components of the spectrum are found at the center of the spectrum and manifest the least saturation. The outline of the spectrum manifests the maximum saturation. The features of a color are identified by calculating the color coordinates x,y of the color. In the color diagram, the color coordinates indicate the colors of the light emitted, respectively.

In view of the aforesaid drawbacks of the prior art, the primary objective of the present invention is to provide a phase-transition composite phosphor synthesis method. The method is advantageously characterized in that M₁₋ₓSi₆N₈:Rₓ phase and M_{2-y}Si₅N₈:R_{y} phase or a two-phase mixture is synthesized by controlling the sintering temperature and duration of a single instance of sintering, where 0≦x<1; 0≦y<2, where M denotes calcium, strontium, barium, or a combination thereof, R denotes a rare earth metal ion, such as Eu²⁺ or Ce³⁺. The method of the present invention entails synthesizing a phosphor which emits composite colors by UV or blue-photoluminescence. The aforesaid synthesis of the present invention dispenses with the hassles of sintering at least two colored phosphors separately or including an additional colored phosphor, and thus the aforesaid synthesis of the present invention cuts the costs of phosphor synthesis. Furthermore, the mixed-phase phosphor which consists of at least two colored phosphors can be polished and screened to form a composite colored phosphor that demonstrates a high degree of uniformity in color.

The objective of the present invention is to provide a sintering technique whereby a phosphor undergoes phase transition to produce another phosphor with another color, such that the composite phosphor has two crystalline phases, wherein the composite phosphor with the two crystalline phases is synthesized and polished under the same condition and thus manifests no difference in particle diameter between the two phosphors, and in consequence the aforesaid blending process is satisfactory.

In the embodiment of the present invention, M₃N₂ (wherein M denotes Ca, Sr and Ba), Si₃N₄ and EuN are reactants, wherein the molar ratio of M:Si:Eu is 2:5:0.02, the phase transition of the phosphor is placed under control at a sintering pressure of 1 atm through 10 atm and a sintering temperature of 1700° C.˜2100° C. and for a sintering duration of 2 to 8 hours.

Upon completion of its phase transition, the phosphor acquires two different crystalline phases, and the two crystalline phase phosphors emit two different colored lights, respectively. The method of the present invention is capable of controlling the ratio of the two crystalline phases of the phosphor, so as to control the colors of the light emitted from phosphor.

After being irradiated by an excitation light of a wavelength of 300˜400 nm, the phosphor comprises a blue nitride phosphor that emits light of a wavelength of 435·475 nm and a red nitride phosphor that emits light of a wavelength of 603˜623 nm.

### BRIEF DESCRIPTION

Objectives, features, and advantages of the present invention are hereunder illustrated with specific embodiments in conjunction with the accompanying drawings, in which:

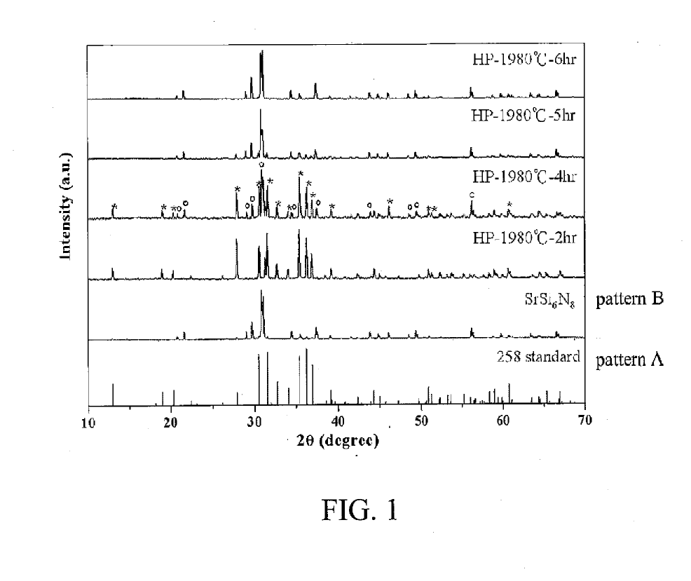

FIG. 1 is a mixed-phase phosphor powder diffraction spectrum according to the embodiment of the present invention;

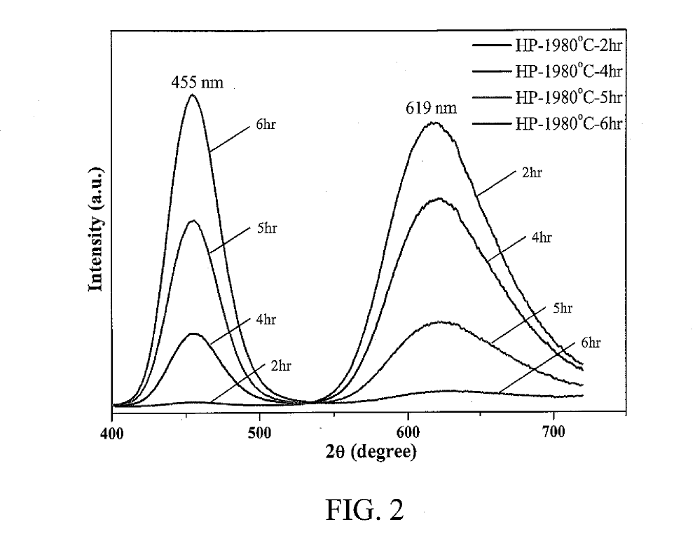

FIG. 2 is a mixed-phase phosphor light emission spectrum according to the embodiment of the present invention;

FIG. 3 is a CIE analysis diagram of a phosphor synthesized for different sintering durations according to the embodiment of the present invention; and

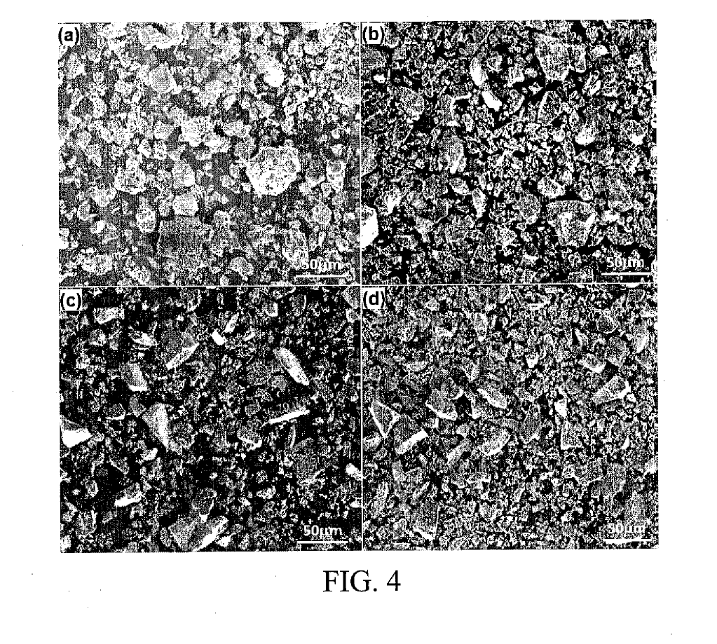

FIG. 4 are SEM images of the phosphor synthesized for different sintering durations according to the embodiment of the present invention.

### DETAILED DESCRIPTION

The light color conversion of a phosphor of the present invention is depicted with color coordinates recommended by the Commission Internationale de l'Éclairage (CIE) and calculated with a computation software recommended by the CIE, using data detected by phosphor photoluminescence spectroscopy (PL) and the difference in color stimulation value between human eyes. The present invention is hereunder illustrated with a specific embodiment whereby persons skilled in the art can readily gain insight into the other advantages and benefits of the present invention. The specific embodiment of the present invention explains the UV-excited pink phosphor synthesis process, spectral properties, and the results of CIE analysis.

M₃N₂ (wherein M denotes an alkaline earth group element, such as calcium, strontium, barium, or a combination thereof), Si₃N₄ and RN_{z} (wherein R denotes a rare earth metal, and z≦1) are for use as a synthesis raw material which undergoes sintering at a nitrogen pressure of 0.5 MPa and a temperature between 1900° C. and 2100° C. for a sintering duration of 2˜6 hours to obtain a phosphor in the form of a mixture of M₁₋ₓSi₆N₈:Rₓ phase and M_{2-y}Si₅N₈:R_{y} phase, wherein 0≦x<1; 0≦y<2, wherein M denotes an alkaline earth group element, such as calcium, strontium, barium, or a combination thereof, wherein R denotes a rare earth metal ion, such as Eu²⁺, Ce³⁺, or a combination thereof In this embodiment, Sr₃N₂, Si₃N₄ and EuN are reactants provided in an appropriate ratio to synthesize the host of Sr_{1.98}Si₅N₈:Eu²⁺_{0.02}, by undergoing sintering at a temperature of 1980° C. and a nitrogen atmosphere of 0.5 MPa (around 5 atm) for a sintering duration of 4˜5 hours. When the sintering process takes place for different sintering durations, Sr_{1.98}Si₅N₈:Eu²_{0.02} undergoes phase transition to different degrees, thereby resulting in different amounts of SrSi₆N₈:Eu²⁺ phase produced as a result of the phase transition of Sr₂Si₅N₈:Eu²⁺, and thereby producing a mixed-phase phosphor including Sr₂Si₅N₈:Eu²⁺ phase and SrSi₆N₈:Eu²⁺ phase with varying ratio therebetween.

Referring to FIG. 1, there is shown a mixed-phase phosphor powder diffraction spectrum according to the embodiment of the present invention. As shown in FIG. 1, the mixed-phase phosphor powder diffraction spectrum illustrates the result of X-ray powder diffraction analysis of the crystalline structure of the phosphor sintered according to the embodiment of the present invention, wherein pattern A is the powder diffraction spectrum pattern of the red phosphor of the pure phase Sr₂Si₅N₈:Eu²⁺ under 258 standard, and pattern B is the powder diffraction spectrum pattern of the blue phosphor of the pure phase SrSi₆N₈:Eu²⁺. According to the embodiment of the present invention, the crystal produced by a sintering process carried out for two hours is the red phosphor of Sr₂Si₅N₈:Eu²⁺. If the sintering duration is four hours, the ratio of Sr₂Si₅N₈:Eu²⁺phase to SrSi₆N₈:Eu²⁺ phase is around 1:1, wherein * indicates a diffraction peak of Sr₂Si₅N₈:Eu²⁺, and indicates a diffraction peak of SrSi₆N₈:Eu²⁺; in the event of a sintering duration of five hours, the amount of Sr₂Si₅N₈:Eu²⁺ phase decreases markedly, whereas there is a large amount of SrSi₆N₈:Eu²⁺ phase; after the sintering process has been carried out for six hours, the amount of SrSi₆N₈:Eu²⁺ phase produced is at its highest level.

Referring to FIG. 2, there is shown a mixed-phase phosphor light emission spectrum according to the embodiment of the present invention. As shown in FIG. 2, there is shown a light emission spectrum of a two-phase nitride phosphor synthesized for a sintering duration of 4˜5 hours according to the embodiment of the present invention. Under the UV-photoluminescence that takes place at a wavelength of 365 nm, the two-phase nitride phosphor emits blue light and red light whose frequency peaks at 455 nm and 619 nm, respectively. After having been sintered for 4 hours, the mixed-phase phosphor still mainly emits red light of a wavelength of 619 nm but starts to emit, albeit slightly, blue light of a wavelength of 455 nm. After having been sintered for 5 hours, the mixed-phase phosphor features a relatively high proportion of SrSi₆N₈:Eu²⁺, but the phosphor light emission spectrum shows that 455 nm blue light equals 619 nm red light in light intensity, and the mixing process results in the emission of pink light. Hence, the present invention is conducive to the application of a pink phosphor and a green or yellow phosphor to UV-excited high color rendering white LED.

Referring to FIG. 3, there is shown a CIE analysis diagram of a phosphor synthesized for different sintering durations according to the embodiment of the present invention. As shown in

FIG. 3, CIE analysis spectrum patterns of the two-phase nitride phosphor are plotted with regard to a sintering process performed for respective sintering durations of 2, 4, 5, 6 hours, indicating that the color of the two-phase nitride phosphor changes as the sintering process keeps going. The color of the two-phase nitride phosphor is red-orange (0.6189, 0.3703) at the end of the two-hour sintering session. The color of the two-phase nitride phosphor is red (0.5113, 0.2932) at the end of the four-hour sintering session. The color of the two-phase nitride phosphor is pink (0.3538, 0.185) at the end of the five-hour sintering session. The color of the two-phase nitride phosphor is blue (0.1724, 0.0639) at the end of the six-hour sintering session. A straight line passes through the aforesaid four coordinates. If there is no color deviation at the two ends of the straight line, the coordinates of any color resulting from a mixture of two colors will lie on the straight line. According to the embodiment of the present invention, at the end of the two-hour sintering session, the proportion of Sr₂Si₅N₈:Eu²⁺ phase in the two-phase composite phosphor is at its highest level but keeps decreasing as the sintering process continues. Eventually, the proportion of SrSi₆N₈:Eu²⁺ phase in the two-phase composite phosphor is at its highest level, indicating that the present invention has the potential to increase the color temperature of the white LED by controlling the color of the yellow or green phosphor.

Referring to FIG. 4, there are shown SEM images of the phosphor synthesized for different sintering durations according to the embodiment of the present invention. The sintering process entails sintering Sr₃N₂, Si₃N₄ and EuN in a nitrogen atmosphere at 0.5 MPa, and 1980° C. for 2 hours, 4 hours, 5 hours, and 6 hours. FIG. 4(a) is an SEM image of the phosphor synthesized for 2 hours. FIG. 4(b) is an SEM image of the phosphor synthesized for 4 hours. FIG. 4(c) is an SEM image of the phosphor synthesized for 5 hours. FIG. 4(d) is an SEM image of the phosphor synthesized for 6 hours. The aforesaid SEM images show that the phosphor thus synthesized has a particle diameter of 10-50 μm.

### Embodiment 1: Synthesis of Sr_{1.98}Si₅N₈:Eu²⁺_{0.02}

In embodiment 1, the synthesis of Sr₁₉₈Si₅N₈:Eu²_{0.02} is carried out with the aforesaid reactants at 0.5 MPa, and 1980° C. for 2 hours. Referring to FIG. 1, under the aforesaid conditions, the resultant phosphor is restricted to the pure phase of Sr₂Si₅N₈:Eu²⁺. Referring to FIG. 2, at the end of the two-hour sintering session, the resultant phosphor is restricted to the pure phase of Sr₂Si₅N₈:Eu²⁺ which emits red light of a wavelength of 619 nm, but does not emit any blue light. Referring to FIG. 3, the pure phase of Sr₂Si₅N₈:Eu²⁺ takes on an red-orange color and has color coordinates (0.6189, 0.3703).

### Embodiment 2: Synthesis of SrSi₆N₈:Eu²⁺

In embodiment 2, the synthesis of SrSi₆N₈:Eu²⁺ is carried out with the aforesaid reactants at 0.5 MPa, and 1980° C. for 6 hours. Referring to FIG. 1, under the aforesaid conditions, the resultant phosphor is restricted to the pure phase of SrSi₆N₈:Eu²⁺. Referring to FIG. 2, at the end of the six-hour sintering session, the resultant phosphor is restricted to the pure phase of SrSi₆N₈ : Eu²⁺ which emits blue light of a wavelength of 455 nm, but does not emit any red light. Referring to FIG. 3, the pure phase of SrSi₆N₈ : Eu²⁺ takes on a blue color and has color coordinates (0.1724, 0.0639).

The present invention is disclosed above by preferred embodiments. However, persons skilled in the art should understand that the preferred embodiments are illustrative of the present invention only, but should not be interpreted as restrictive of the scope of the present invention. Hence, all modifications and variations made to the aforesaid embodiments without departing from the spirit and scope of the present invention should fall within the scope of the present invention. Accordingly, the legal protection for the present invention should be defined by the appended claims.

What is claimed is:

1. A method of synthesizing a composite phosphor by phase transition, the method comprising the steps of:
(a) mixing M₃N₂, Si₃N₄, and RN_{z} for use as a synthesis raw material, where M denotes an alkaline earth group element, R denotes a rare earth metal, and z≦1;
(b) sintering the synthesis raw material by a high-temperature sintering process,
wherein the composite phosphor including M₁₋ₓSi₆N₈:Rₓ phase phosphor and M_{2-y}Si₅N₈:R_{y} phase phosphor is formed by controlling a sintering temperature and a sintering duration of the high-temperature sintering process, where 0≦x<1 and 0≦y<2.

2. The method of synthesizing the composite phosphor by phase transition as recited in claim 1, wherein a molar ratio of M:Si:R in the synthesis raw material equals 2−x:5:x (0<x<2).

3. The method of synthesizing the composite phosphor by phase transition as recited in claim 1, wherein the sintering duration of the high-temperature sintering process ranges from 2 hours to 8 hours.

4. The method of synthesizing the composite phosphor by phase transition as recited in claim 1, wherein the sintering temperature of the high-temperature sintering process ranges from 1700° C. to 2100° C.

5. The method of synthesizing the composite phosphor by phase transition as recited in claim 1, wherein the high-temperature sintering process occurs at a pressure of 1 atm to 10 atm.

6. The method of synthesizing the composite phosphor by phase transition as recited in claim 1, wherein the composite phosphor is of a UV-excited wavelength of 300˜400 nm and a blue-photoluminescence-excited wavelength of 420˜480 nm.

7. The method of synthesizing the composite phosphor by phase transition as recited in claim 1, wherein the sintering duration ranges from 3 hours to 7 hours.

8. The method of synthesizing the composite phosphor by phase transition as recited in claim 1, wherein the composite phosphor is present simultaneously in two phases in form of a reactant and a product, respectively, and the phase transition therebetween is reversible.
